(19) United States
(12) Patent Application Publication
(10) Pub. No.: US 2014/0082023 A1
(43) Pub. Date: Mar. 20, 2014

(54) ASSOCIATING AN IDENTITY TO A CREATOR OF A SET OF VISUAL FILES

(71) Applicants: Shmuel Ur, Shorashim (IL); Shay Bushinsky, Ganei Tikva (IL)

(72) Inventors: Shmuel Ur, Shorashim (IL); Shay Bushinsky, Ganei Tikva (IL)

(73) Assignee: EMPIRE TECHNOLOGY DEVELOPMENT LLC, Wilmington, DE (US)

(21) Appl. No.: 13/808,889

(22) PCT Filed: Sep. 14, 2012
(86) PCT No.: PCT/US12/55370

§ 371 Date: Jan. 7, 2013

(51) Int. Cl. G06F 17/30

(52) U.S. Cl. CPC G06F 17/3028
USPC 707/783

(57) ABSTRACT

Technologies and implementations for associating a personal identity of a creator to a set of visual files are generally disclosed.

### BACKGROUND

Unless otherwise indicated herein, the approaches described in this section are not prior art to the claims in this application and are not admitted to be prior art by inclusion in this section.

With the rise in popularity of social networks and cloud based storage, visual files (e.g., photographs and videos) are increasingly being shared, both with the public and with limited groups. As such, the number of visual files available for indexing in databases is increasing. Additionally, supplementary information about the visual files is often available for inclusion in these databases. For example, information such as the subject of a visual file may be determined using face or object recognition. The equipment used to create a visual file may be determined from metadata associated with the visual file. These and many other pieces of information about a visual file are available or can be determined. Although a large number of visual files and information about the visual files may be available, the creators of the visual files are often unknown.

### SUMMARY

Described herein are various illustrative methods for associating an identity of a creator of a set of visual files with the set of visual files. Example methods may include determining the set of visual files from a visual file database having a plurality of visual files and data associated with each of the visual files, wherein the set of visual files are attributable to a visual file creator, determining the personal identity related to the visual file creator attributed to the set of visual files, and including the personal identity in the data associated with each of the visual files in the set of visual files in the visual file database.

The present disclosure also describes various example machine readable non-transitory medium having stored therein instructions that, when executed, cause a device to associate the identity of a creator of a set of visual files with the set of visual files. Example machine readable non-transitory media may have stored therein instructions that, when executed, cause the device to associate the identity of a creator of a set of visual files with the set of visual files by determining the set of visual files from a visual file database having a plurality of visual files and data associated with each of the visual files, wherein the set of visual files are attributable to a visual file creator, determining the personal identity related to the visual file creator attributed to the set of visual files, and including the personal identity in the data associated with each of the visual files in the set of visual files in the visual file database.

The present disclosure additionally describes example devices. Example devices may include a processor and a machine readable medium having stored therein instructions that, when executed, cause the device to associate the identity of a creator of a set of visual files with the set of visual files by determining the set of visual files from a visual file database having a plurality of visual files and data associated with each of the visual files, wherein the set of visual files are attributable to a visual file creator, determining the personal identity related to the visual file creator attributed to the set of visual files, and including the personal identity in the data associated with each of the visual files in the set of visual files in the visual file database.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 is an illustration of a block diagram of an example visual file database;

FIG. 2 is an illustration of a block diagram of an example system for associating an identity to a creator of a set of visual files;

FIG. 3 is an illustration of a flow diagram of an example method for associating an identity to a creator of a set of visual files;

FIG. 4 is an illustration of a flow diagram of an example method for determining a personal identity of a creator of a set of visual files;

FIG. 5 is an illustration of a flow diagram of an example method for associating a personal identity of a creator to a visual file;

FIG. 6 is an illustration of an example computer program product; and

FIG. 7 is an illustration of a block diagram of an example computing device, all arranged in accordance with at least some embodiments of the present disclosure.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, devices, systems and computer readable media related to associating an identity of a creator of a set of visual files with the set of visual files.

As indicated above, visual files may be increasingly becoming available. For example, the number of visual files available online (e.g., in social networking sites, cloud based sharing services, or the like) may be increasing. These visual files may be publically available and may be included in databases of visual files. Furthermore, information about the visual files, such as, for example, the subject of the visual file, the equipment used to capture the visual file, or the like may be determined from the visual file. However, the creator (e.g., photographer, videographer, or the like) of the visual file, and particularly the personal identity of the creator, may often be unknown. Using various implementations of the disclosed subject matter, a personal identity of the creator of a set of visual files in a visual file database may be determined and associated with the visual files. The identity of the creator may be of particular interest to users of visual file databases, such as, for example, search engine companies, advertisers, government agencies, private companies, or social media organizations, or the like.

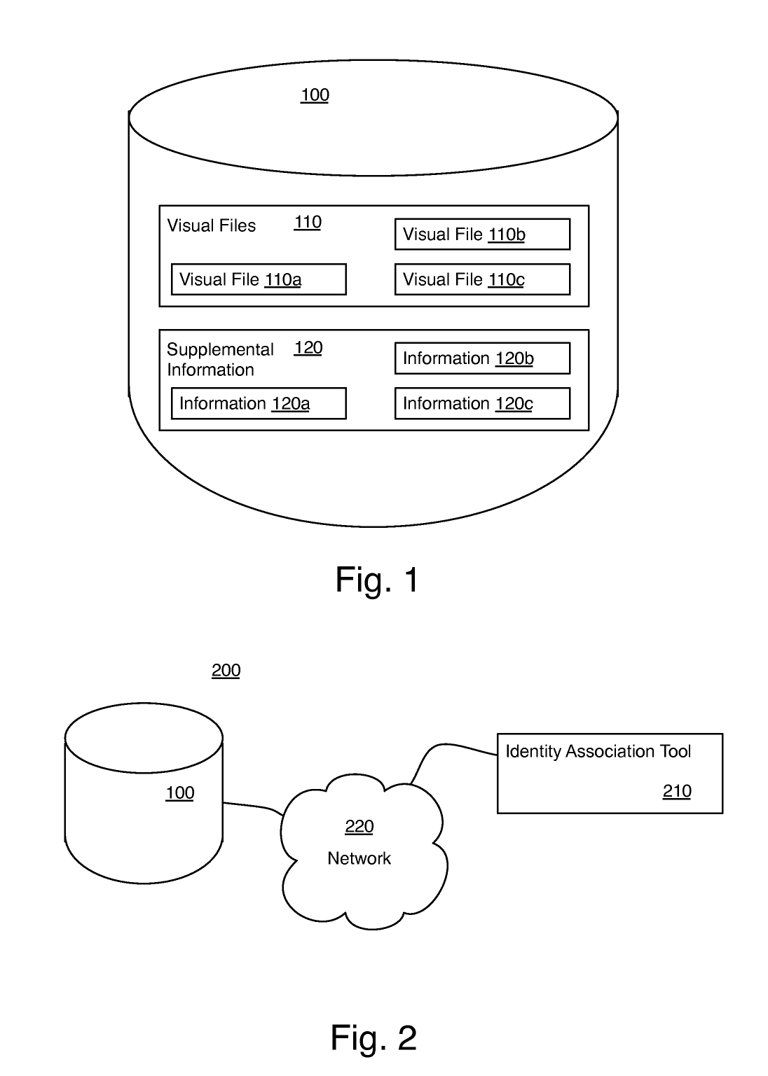

FIG. 1 is an illustration of a block diagram of an example visual file database 100, arranged in accordance with at least some embodiments of the present disclosure. As shown, visual file database 100 may have visual files 110 and/or supplemental information 120 represented therein. In general, database 100 may be implemented from any available database structure. For example, database 100 may be implemented using any combination of database standards, such as, for example, SQL, ODBC, or the like. In general, database 100 may follow any available database model, such as, for example, relational, object, relational-object, hierarchical, or the like, and may have any suitable schema. Furthermore, database 100 may be implemented using a computer, a server, multiple computers and/or servers networked together, a machine readable storage medium, or the like.

As discussed, database 100 may include visual files 110 and supplemental information 120. In some examples, databases 100 may index, relate, catalog, or otherwise reference visual files 110 and supplemental information 120. For example, as shown in FIG. 1, visual files 110 may include visual files 110a, 110b and 110c. Also as shown in FIG. 1, supplemental information 120 may include information 120a, 120b and 120c. For clarity of presentation, database 100 is shown indexing three visual files and three items or pieces of supplemental information 120. However, as will be appreciated, various examples of the disclosed subject matter do not place a limit on the number of visual files 110 and amount of supplemental information 120 indexed in the database 100.

In general, visual files 110 may include any suitable visual file or files. In some examples, visual files 110 may include image files, video files, or some combination of both image and video files. In general, supplemental information 120 may include any data and/or information related to visual files 110. In some examples, supplemental information 120 may include information about one or more of visual files 110 extracted from metadata associated with visual files 110. For example, supplemental information 120 may include exchangeable image file (EXIF) data associated with one or more of visual files 110. In some examples, supplemental information 120 may include the creation date and/or time of one or more of visual files 110. In some examples, supplemental information 120 may include the location of creation (e.g., GPS coordinates, or the like) of one or more of visual files 110 (i.e., the location where one or more of visual files 110 were created). In some examples, supplemental information 120 may include information related to the equipment used to create one or more of visual files 110 (e.g., camera type, serial number, or the like). In some examples, supplemental information 120 may include parameters associated with the creation of one or more of visual files 110 (e.g., white balance, ISO, resolution, file format, or the like). In some examples, supplemental information 120 may include information about whether one or more of visual files 110 were created manually, automatically, by use of a timer, or the like. In some examples, supplemental information 120 may include post creation effects applied to one or more of visual files 110 (e.g., contrast sharpening or dulling, or the like).

In some examples, supplemental information 120 may include information extracted from visual files 110. For example, supplemental information 120 may include the direction the creator of visual file 110 was facing at the time visual file 110 was created. In some examples, supplemental information 120 may include stylistic qualities of one or more of visual files 110 (e.g., whether partial or whole objects were captured, use of negative space, position of the horizon, or the like). In some examples, supplemental information 120 may include geographic references, landmarks, or other location markers present in one or more of visual files 110. In some examples, supplemental information 120 may include the time of day, time or year, and/or season one or more of visual files 110 were created, as evidenced by environmental qualities (e.g., weather, light, sun position, or the like) present in the visual file 110. In some examples, supplemental information 120 may include subjects (e.g., people, animals, or the like) present in one or more of visual files 110.

With some examples, supplemental information 120 may include information regarding visual files 110 from the source of the visual files 110. For example, supplemental information 120 may include information from text available at the source of one or more of visual files 110. In some examples, text (e.g., captions, descriptions, blogs entries, or the like) available at the source (e.g., webpage, blog entry, social network tag, or the like) of one or more of visual files 110 may provide supplemental information 120. Examples of such supplemental information may include names, locations, times, subjects, or the like, which may be detailed in the text. In some examples, supplemental information 120 may include ownership information (e.g., uploader ID, album owner, or the like) for one or more of visual files 110. In some examples, supplemental information 120 may include information such as, the setting (e.g., park, school, or the like) of one or more of visual files 110. In some examples, supplemental information 120 may include information such as, the event (e.g., wedding, sports game, or the like) corresponding to one or more of visual files 110.

The example types of supplemental information 120 detailed above are not intended to be an exhaustive listing. Furthermore, some visual files 110 (e.g., visual files 110a and 110b) may have one type of supplemental information 120 associated with them, while other visual files 110 (e.g., visual file 110c) do not have that type of associated supplemental information 120. Furthermore, the types of supplemental information 120 that may be available in database 100 may vary, as will be appreciated from the disclosure

The above described example database 100, visual files 110 and supplemental information 120 may be used to detail various implementations of the disclosed subject matter. Particularly, the examples of supplemental information 120 provided above will be referenced in describing illustrative implementations of the disclosed subject matter. However, it is to be appreciated that the disclosed subject matter is not limited to use with visual file database 100 detailed in FIG. 1 or the example types of supplemental information 120 provided above, and accordingly, the claimed subject matter is not limited in these respects.

Various implementations of the disclosed subject matter may provide for the personal identity of a creator of a visual file or a set of visual files in a visual file database to be determined and associated with the visual files. FIG. 2 is an illustration of an example system 200 for associating an identity to a set of visual files, arranged in accordance with some implementations of the disclosed subject matter. As shown, system 200 may include visual file database 100. Also as shown, system 200 may include an identity association tool 210. A network 220 may connect the identity association tool 210 and the database 100. In general, network 220 may include any suitable communication medium. In some examples, network 220 may be the Internet, a local area network, or the like.

In general, identity association tool 210 may include logic and/or features configured to determine the identity of a creator of one or more of visual files 110 in database 100 using supplemental information 120. In some examples, identity association tool 210 may use more than one database to determine the identity of a creator of one or more of visual files 110. For example, although not shown in FIG. 2, identity association tool 210 may communicatively connect to database 100 and another database (not shown). In some examples, visual files 110 may be referenced in one database (e.g., database 100) and supplemental information 120 may be referenced in one or more other database (not shown). In some examples, identity association tool 210 may determine some of supplemental information 120 and add that information to database 100 prior to determining the identity of the creator of a set of visual files. In some examples, identity association tool 210 may determine some of supplemental information 120 and add that information to database 100 as part of determining the identity of the creator of a set of visual files.

In some examples, identity association tool 210 may be a computer program, which may operate on a computer connected to network 220. In some examples, identity association tool 210 may be computer executable instructions, which may operate on a computer connected to network 220. In general, identity association tool 210 may connect to database 100 and may identify visual files stored in the database 100, which may be attributable to a visual file creator. Identity association tool 210 may then determine a personal identity for the creator and may associate the determined identity with the identified visual files.

In some examples, identity association tool 210 may include logic and/or features configured to associate a personal identity to a creator of one or more visual files using machine learning and/or statistical techniques. In some examples, the machine learning and/or statistical techniques may include decision trees, neural networks, Bayesian networks, genetic algorithms, support vector machines, Self Organizing Maps, Hidden Markov Models, or the like. In some examples, the machine learning and/or statistical methods may be trained using various techniques including a training set, a validation set, and/or a testing set, or the like.

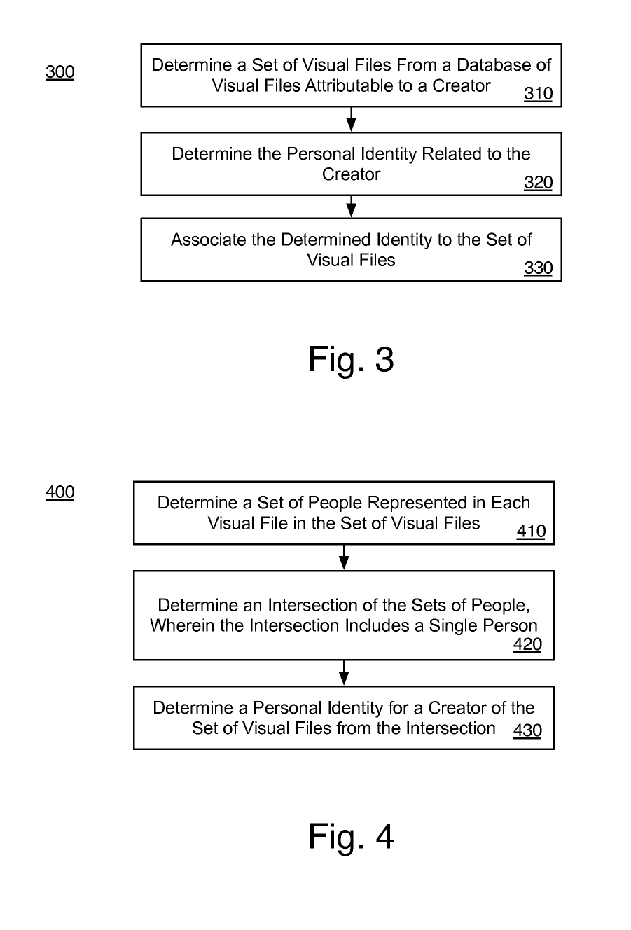

FIGS. 3, 4 and 5 illustrate flow diagrams of example methods for associating an identity of a creator to a set of visual files, arranged in accordance with at least some embodiments of the present disclosure. In some portions of the description, illustrative implementations of the methods are described with reference to elements of database 100 and system 200 depicted in FIGS. 1 and 2. However, the described embodiments are not limited to these depictions. For example, some elements depicted in FIGS. 1 and 2 may be omitted from example implementations of the methods detailed herein. Furthermore, other elements not depicted in FIGS. 1 and 2 may be used to implement example methods.

Additionally, FIGS. 3, 4 and 5 employ block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

FIG. 3 is an illustration of a flow diagram of an example method 300 for attributing a personal identity to a set of visual files, arranged in accordance with at least some embodiments of the present disclosure. Beginning at block 310 (determine a set of visual files from a database of visual files attributable to a creator), identity association tool 210 may include logic and/or features configured to determine a set of visual files 110 that may be attributable to a creator. In general, at block 310, identity association tool 210 may determine visual files 110 that likely have the same creator based on supplemental information 120. As used herein, the creator may mean the person responsible for creating the visual files 110 in the set of visual files. For example, the photographer or videographer of a set of visual files may be the creator. In some examples, the creator may mean the entity responsible for creation. For example, visual files 110 may be created as part of a larger project (e.g., mapping street views, or the like). In such cases, the visual files may often be created automatically. As such, the creator may mean the entity responsible for the project.

In general, visual files 110 that may be attributable to a creator, may be referred to herein as the set of visual files. With some examples, the set of visual files may include less than the total number of visual files 110 represented in database 100. However, it is to be appreciated, that when referencing “the set of visual files” it is intended that this mean the visual files 110 from the visual file database 100 that are attributable to a particular creator as determined at block 310. For example, visual files 110a and 110b may be determined to be attributable to a creator at block 310. Accordingly, the set of visual files may include the visual files 110a and 110b.

In some examples, identity association tool 210 may search (e.g., query) database 100 for supplemental data 120 that may facilitate attribution to a creator. For example, identity association tool 210 may identify visual files 110 having associated supplemental information 120 that may indicate the creator of visual files 110 may be the same. For example, visual files 110 that may be associated with the same pseudonym (e.g., uploader ID, account number, album owner, or the like) may be included in the set of visual files at block 310. Alternatively, visual files 110 created with the same equipment (e.g., based on metadata, tags, etc.) may be included in the set of visual files at block 310. In other examples the set of visual files may be determined by visual files appearing in the same location online, visual files being taken at a similar place and/or time, or visual files having a similar style (e.g., use of negative space, or the like), or the like.

In some examples, a combination of characteristics may be used to determine the set of visual files. For example, visual files 110 attributable to a similar place and time and visual files 110 having a similar style may be determined to be attributable to a particular creator. In various examples, the set of visual files attributable to a creator may be determined by a weighted combination of attributes of supplemental data 120.

As discussed herein, in some examples, identity association tool 210 may include logic and/or features configured to implement various machine learning and/or statistical techniques. In some examples, such techniques may be used to determine a set of visual files attributable to a creator. For example, identity association tool 210 may be configured to distinguish between visual files 110 attributable to a particular creator and other visual files 110. In some examples, a collection of visual files 110 known to be attributable to a particular creator may be used to configure the identity association tool (e.g., through machine learning training techniques, or the like) to distinguish between visual files as described above. In some examples, this may be facilitated by “training” identity association tool 210 to distinguish based on particular features of visual files 110, such as, for example, metadata information, or stylistic qualities, or the like. In some examples, identity association tool 210 may be “trained” to distinguish based on likely equipment used to create the visual files 110. For example, visual file creation equipment (e.g., cameras, video recorders, or the like) may include hidden features (e.g., bad pixels, or the like) that may constitute a unique signature of the equipment.

Continuing from block 310 to block 320 (determine the personal identity related to the creator), identity association tool 210 may include logic and/or features configured to determine a personal identity related to the creator. In general, identity association tool 210 may determine the personal identity by searching (e.g., querying, mining, or the like) database 100 for a personal identity of the creator. In some examples, the creator may be personally identified by matching the serial number of an image capture device (e.g., camera, video recorder, or the like) against a list of equipment ownership records. For example, if supplemental data 120 includes a serial number of the image capture device used to create one of the visual files 110 in the set of visual files, this serial number may be compared against an image capture device ownership database.

In some examples, supplemental information 120 may identify the creator. For example, information (e.g., social network tags, captions, descriptions, blog posts, or the like) may be used to personally identify the creator of one of the visual files 110 in the set of visual files at block 320.

In some implementations, identity association tool 210 may personally identify the creator from visual files 110. For example, one of visual files 110 may include a reflection of the creator. Accordingly, the creator may be personally identifiable using face recognition techniques applied to the reflection. In some examples, the creator may be a subject in one or more of visual files 110 in the set of visual files. For example, if supplemental information 120 indicated a timer was used to create one of the visual files, the creator may be a subject. As such, the creator may be personally identifiable using face recognition techniques.

In some implementations, identity association tool 210 may match the creator (e.g., as determined using facial recognition) with personally identified subjects in other visual files 110 in database 100. For example, visual files 110 not in the set of visual files, but which were created at similar times and/or locations, may capture the creator in the process of creating one of the visual files 110 in the set of visual files. As such, analysis (e.g., facial recognition, determining the direction the creator was facing, or the like) may be used to identify the creator from visual files 110 where the creator was captured as detailed above.

In some implementations, identity association tool 210 may match the times and/or locations where visual files 110 in the set of visual files were created against a list of persons known to have been in those locations at those times at block 320. In some implementations, the identity association tool 210 may match the events corresponding to the visual files 110 in the set of visual files against a list of persons know to have been at those events.

Detailed above are multiple example techniques to determine the personal identity related to the creator of a set of visual files. In some implementations, more that one of these techniques are used to determine the personal identity of the creator at block 320. For example, a personal identity may be determined using more than one technique (e.g., using the example techniques detailed above, or other techniques), which may result in multiple personal identities being determined. Accordingly, a weighting of the various results may be made at block 320. The weighting may be applied to determined the most likely identity to select from the possible identities. In some implementations, the weighting may be based upon selected optimal results, optimum names, objects, locations or other data associated with visual files 110 in the set of visual files. Additionally, other qualities may be used in the weighting, such as, for example, a difficulty or rarity of the possible identity. In some implementations, link analysis algorithms may be used to select the most likely identity.

Continuing from block 320 to block 330 (associate the determined identity to the set of visual files), identity association tool 210 may include logic and/or features configured to associate the determined personal identity to the set of visual files. In general, identity association tool 210 may add the personal identity to database 100 (e.g., by insertion into a creator identity field, or the like) and relate (e.g., by linking or the like) the personal identity to visual files 110 in the set of visual files. In some examples, identity association tool 210 may add new supplemental information 120 relating the determined personal identity to visual files 110 in the set of visual files at block 330.

The present disclosure details various examples for associating the personal identity of a creator with a set of visual files in a visual file database. Specifically, examples for determining a personal identity related to the creator of a set of visual files may be given with respect to process block 320. FIG. 4 is an illustration of a flow diagram of an example method 400 for determining a personal identity of a creator of a set of visual files, arranged in accordance with at least some embodiments of the present disclosure. In some implementations, the method 400 may be performed at block 320. As shown, method 400 may begin at block 410. At block 410 (determine a set of people represented in each visual file in the set of visual files), the identity association tool may identify (e.g., using face recognition, or the like) the people represented in one or more of visual files 110 in the set of visual files. In some examples, a set of people represented in each of visual files 110 in the set of visual files may be generated at block 410.

Continuing at block 420 (determine an intersection of the sets of people, wherein the intersection includes a single person), identity association tool 210 may determine an intersection of the sets of people. In general, identity association tool 210 may determine an intersection of the sets of people where the intersection includes one person. For example, suppose visual files 110a and 110b were attributed to a creator (e.g., at block 310). Further suppose, sets of people represented in the visual files 110a and 110b were determined at block 410. The sets of people may be compared (e.g., by intersection) to determine which person in the sets of people represented in the visual files 110a and 110b may be in common. In some examples, social network circles or other such social connections may be used to intersect the sets of people.

In some examples, the creator may not be represented in the visual files 110. As such, the creator may not be included in the sets of people. However, by intersecting using social network connections or circles (e.g., social, familial, professional, or the like), a person common to the sets of people may be determined. As discussed, in some examples, at block 410, people represented in one or more of visual files 110 in the set of visual files may be determined. In some examples, a social network of people may be determined for some or all of the people identified in one or more of visual files 110. In some examples, the social network of people may be based on social network websites, professional memberships, familial relationships, or the like. In some examples, identity association tool 210 may determine an intersection of the social networks of people such that the intersection may include one person. In some examples, that person may be represented in one or more of visual files 110. In some examples, that person may not be represented in one or more of visual files 110.

Continuing at block 430 (associate the single person to the personal identity), the identity of the single person determined at block 420 may be associated to the personal identity of the creator.

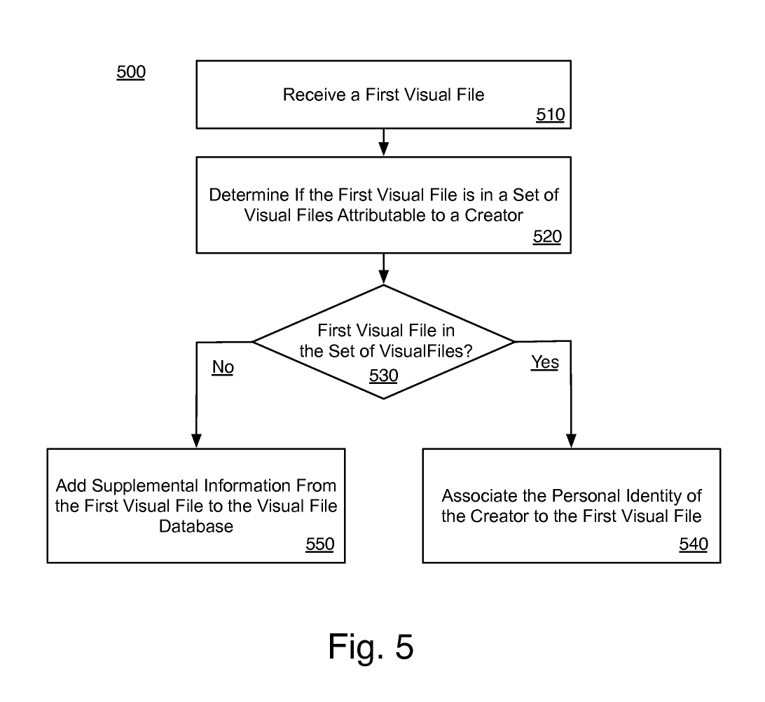

FIG. 5 is an illustration of a flow diagram of an example method 500 for associating the personal identity of a creator to a visual file, arranged in accordance with at least some embodiments of the present disclosure. Beginning at block 510 (receive a first visual file), identity association tool 210 may receive a first visual file. In various examples, identity association tool 210 may include logic and/or features configured to monitor visual file database 100 (or other locations of visual files) for newly added visual files. In some examples, identity association tool 210 may monitor visual file database 100 in “real time”. In some examples, identity association tool 210 may periodically monitor visual file database 100 for newly added visual files. Once a newly added visual file is identified, identity association tool 210 may receive (e.g., by accessing, requesting, loading, sharing, or the like) the newly added visual file. This newly added visual file may be referred to as the first visual file.

Continuing at block 520 (determine if the first visual file is in a set of visual files attributable to a creator), identity association tool 210 may determine whether the first visual file may be in the set of visual files. In some examples, identity association tool 210 may determine whether the first visual file may also be attributable to the creator attributed to the set of the visual files. Various methods for determining if a visual file is attributable to a creator, or whether a visual file is within a set of visual files are detailed above in conjunction with FIGS. 3 and 4. For example, process block 320 of FIG. 3 provides various examples of determining if a visual file is attributable to a creator. Accordingly, these examples are not repeated here.

Continuing at decision block 530 (first visual file in the set of visual files?), method 500 may either proceed at decision block 540 or decision block 550. As shown, if the first visual file is within the set of visual files, then method 500 may continue at block 540. At block 540 (associate the personal identity of the creator to the first visual file), identity association tool 210 may associate the personal identity of the creator of the set of visual files with the first visual file. Various examples of determining a personal identity of a creator and associating the identity with a visual file are provided herein and, in particular, with respect to with FIGS. 3 and 4. As such, these examples are not repeated here.

If the first visual file is not within the set of visual files, then the method may continue at block 550. At block 550 (add supplemental information from the first visual file to the visual file database), identity association tool 210 may include logic and/or features configured to extract supplemental information 120 from the first visual file and add the supplemental information 120 to the visual file database 100.

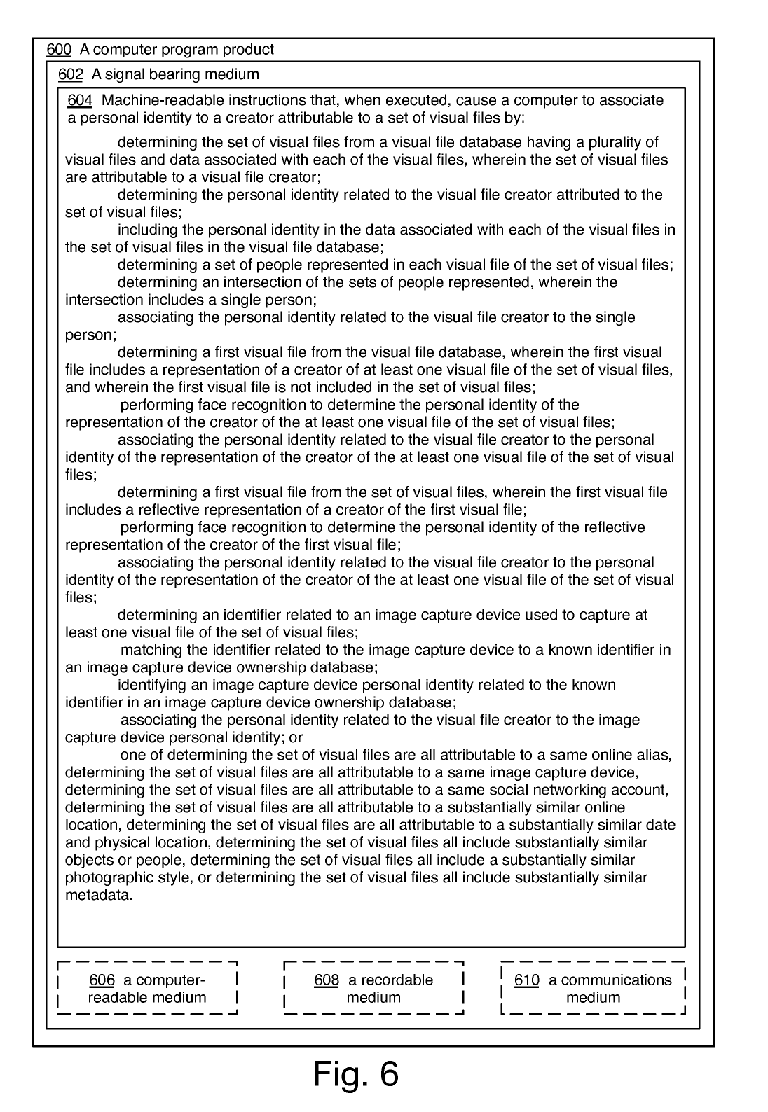

In general, the methods described with respect to FIGS. 3, 4, 5 and elsewhere herein may be implemented as a computer program product, executable on any suitable computing system, or the like. For example, a computer program product for providing data center access and management settings transfer services may be provided. Example computer program products are described with respect to FIG. 6 and elsewhere herein.

FIG. 6 is an illustration of an example computer program product 600, arranged in accordance with at least some embodiments of the present disclosure. Computer program product 600 may include a machine readable non-transitory medium having stored therein a plurality of instructions that, when executed, cause the machine to associate a personal identity with a set of visual files according to the processes and methods discussed herein. Computer program product 600 may include a signal bearing medium 602. Signal bearing medium 602 may include one or more machine-readable instructions 604, which, when executed by one or more processors, may operatively enable a computing device to provide the functionality described herein. In various examples, some or all of the machine-readable instructions may be used by the devices discussed herein.

In some examples, the machine readable instructions 604 may include determining the set of visual files from a visual file database having a plurality of visual files and data associated with each of the visual files, wherein the set of visual files are attributable to a visual file creator. In some examples, the machine readable instructions 604 may include determining the personal identity related to the visual file creator attributed to the set of visual files. In some examples, the machine readable instructions 604 may include including the personal identity in the data associated with each of the visual files in the set of visual files in the visual file database. In some examples, the machine readable instructions 604 may include determining a set of people represented in each visual file of the set of visual files. In some examples, the machine readable instructions 604 may include determining an intersection of the sets of people represented, wherein the intersection includes a single person. In some examples, the machine readable instructions 604 may include associating the personal identity related to the visual file creator to the single person. In some examples, the machine readable instructions 604 may include determining a first visual file from the visual file database, wherein the first visual file includes a representation of a creator of at least one visual file of the set of visual files, and wherein the first visual file is not included in the set of visual files. In some examples, the machine readable instructions 604 may include performing face recognition to determine the personal identity of the representation of the creator of the at least one visual file of the set of visual files. In some examples, the machine readable instructions 604 may include associating the personal identity related to the visual file creator to the personal identity of the representation of the creator of the at least one visual file of the set of visual files. In some examples, the machine readable instructions 604 may include determining a first visual file from the set of visual files, wherein the first visual file includes a reflective representation of a creator of the first visual file. In some examples, the machine readable instructions 604 may include performing face recognition to determine the personal identity of the reflective representation of the creator of the first visual file. In some examples, the machine readable instructions 604 may include associating the personal identity related to the visual file creator to the personal identity of the representation of the creator of the at least one visual file of the set of visual files. In some examples, the machine readable instructions 604 may include determining an identifier related to an image capture device used to capture at least one visual file of the set of visual files. In some examples, the machine readable instructions 604 may include matching the identifier related to the image capture device to a known identifier in an image capture device ownership database. In some examples, the machine readable instructions 604 may include identifying an image capture device personal identity related to the known identifier in an image capture device ownership database. In some examples, the machine readable instructions 604 may include associating the personal identity related to the visual file creator to the image capture device personal identity. In some examples, the machine readable instructions 604 may include one of determining the set of visual files are all attributable to a same online alias, determining the set of visual files are all attributable to a same image capture device, determining the set of visual files are all attributable to a same social networking account, determining the set of visual files are all attributable to a substantially similar online location, determining the set of visual files are all attributable to a substantially similar date and physical location, determining the set of visual files all include substantially similar objects or people, determining the set of visual files all include a substantially similar photographic style, or determining the set of visual files all include substantially similar metadata.

In some implementations, signal bearing medium 602 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communication link, a wireless communication link, etc.). In some examples, the signal bearing medium 602 may encompass a machine readable non-transitory medium.

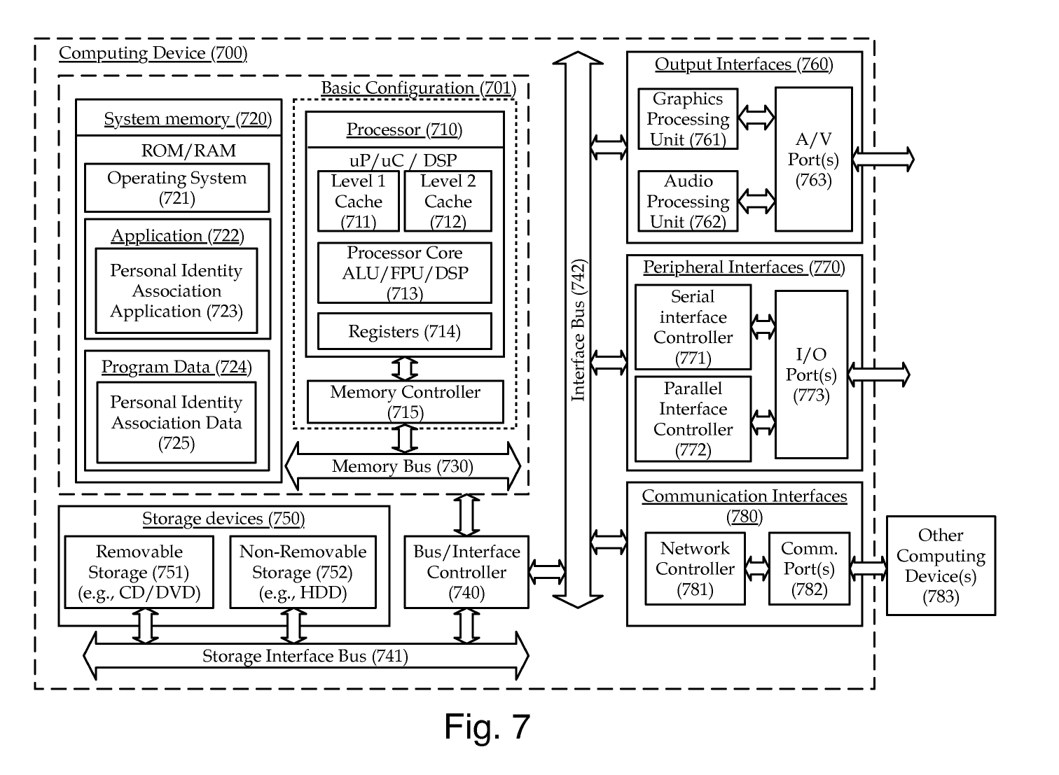

In general, the methods described with respect to FIGS. 2, 3 and 4 and elsewhere herein may be implemented in any suitable server and/or computing system. Example systems may be described with respect to FIG. 7 and elsewhere herein. In some examples, a resource, data center, data cluster, cloud computing environment, or other system as discussed herein may be implemented over multiple physical sites or locations. In general, the computer system may be configured to provide data center access and management settings transfer services.

FIG. 7 is an illustration of a block diagram of an example computing device 700, arranged in accordance with at least some embodiments of the present disclosure. In various examples, computing device 700 may be configured to associate a personal identity to a set of visual files as discussed herein. In various examples, computing device 700 may be configured to associate a personal identity to a set of visual files as a server system or as a tool as discussed herein. In one example of a basic configuration 701, computing device 700 may include one or more processors 710 and a system memory 720. A memory bus 730 can be used for communicating between the one or more processors 710 and the system memory 720.

Depending on the desired configuration, the one or more processors 710 may be of any type including but not limited to a microprocessor (μP), a microcontroller (μC), a digital signal processor (DSP), or any combination thereof. The one or more processors 710 may include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the one or more processors 710, or in some implementations the memory controller 715 can be an internal part of the processor 710.

Depending on the desired configuration, the system memory 720 may be of any type including but not limited to volatile memory (such as RAM), non-volatile memory (such as ROM, flash memory, etc.) or any combination thereof. The system memory 720 may include an operating system 721, one or more applications 722, and program data 724. The one or more applications 722 may include personal identity association application 723 that may be arranged to perform the functions, actions, and/or operations as described herein including the functional blocks, actions, and/or operations described herein. The program data 724 may include personal identity association data 725 for use with access and management settings transfer application 723. In some example embodiments, the one or more applications 722 may be arranged to operate with the program data 724 on the operating system 721. This described basic configuration 701 is illustrated in FIG. 7 by those components within dashed line.

Computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The one or more data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 720, the removable storage 751 and the non-removable storage 752 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 742 for facilitating communication from various interface devices (e.g., output interfaces, peripheral interfaces, and communication interfaces) to the basic configuration 701 via the bus/interface controller 740. Example output interfaces 760 may include a graphics processing unit 761 and an audio processing unit 762, which may be configured to communicate to various external devices such as a display or speakers via one or more NV ports 763. Example peripheral interfaces 770 may include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which may be arranged to facilitate communications with one or more other computing devices 783 over a network communication via one or more communication ports 782. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 700 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 700 may also be implemented as a personal computer including both laptop computer and non-laptop computer configurations. In addition, the computing device 700 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for attributing a personal identity to a set of visual files comprising:
determining the set of visual files from a visual file database having a plurality of visual files and data associated with each of the visual files, wherein the set of visual files are attributable to a visual file creator;
determining the personal identity related to the visual file creator attributed to the set of visual files; and
including the personal identity in the data associated with each of the visual files in the set of visual files in the visual file database.

2. The method of claim 1, wherein determining the personal identity related to the visual file creator comprises:
determining a set of people represented in each visual file of the set of visual files;
determining an intersection of the sets of people represented, wherein the intersection includes a single person; and
associating the personal identity related to the visual file creator to the single person.

3. The method of claim 1, wherein determining the personal identity related to the visual file creator comprises:
determining a set of people represented in each visual file of the set of visual files;
determining a person having the most occurrences in the sets of people represented; and
associating the personal identity related to the visual file creator to the person having the most occurrences.

4. The method of claim 1, wherein determining the personal identity related to the visual file creator comprises:
determining a first visual file from the visual file database, wherein the first visual file includes a representation of a creator of at least one visual file of the set of visual files, and wherein the first visual file is not included in the set of visual files;
performing face recognition to determine the personal identity of the representation of the creator of the at least one visual file of the set of visual files; and
associating the personal identity related to the visual file creator to the personal identity of the representation of the creator of the at least one visual file of the set of visual files.

5. The method of claim 1, wherein determining the personal identity related to the visual file creator comprises:
determining a first visual file from the set of visual files, wherein the first visual file includes a reflective representation of a creator of the first visual file;
performing face recognition to determine the personal identity of the reflective representation of the creator of the first visual file; and
associating the personal identity related to the visual file creator to the personal identity of the representation of the creator of the at least one visual file of the set of visual files.

6. The method of claim 1, wherein determining the personal identity related to the visual file creator comprises:
determining a known creator of a first visual file of the set of visual files; and
associating the personal identity related to the visual file creator to the known creator of the first visual file of the set of visual files.

7. The method of claim 1, wherein determining the personal identity related to the visual file creator comprises:
determining a known creator of a first visual file of the set of visual files based on at least one of analyzing metadata of the first visual file having a photographer name or analyzing a social networking account having an account holder name; and
associating the personal identity related to the visual file creator to the known creator of the first visual file of the set of visual files.

8. The method of claim 1, wherein determining the personal identity related to the visual file creator comprises:
determining an identifier related to an image capture device used to capture at least one visual file of the set of visual files;
matching the identifier related to the image capture device to a known identifier in an image capture device ownership database;
identifying an image capture device personal identity related to the known identifier in an image capture device ownership database; and
associating the personal identity related to the visual file creator to the image capture device personal identity.

9. The method of claim 1, wherein determining the set of visual files from the visual file database comprises at least one of determining the set of visual files are all attributable to a same online alias, determining the set of visual files are all attributable to a same image capture device, determining the set of visual files are all attributable to a same social networking account, determining the set of visual files are all attributable to a substantially similar online location, determining the set of visual files are all attributable to a substantially similar date and physical location, determining the set of visual files all include substantially similar objects or people, determining the set of visual files all include a substantially similar photographic style, or determining the set of visual files all include substantially similar metadata.

10. The method of claim 1, wherein determining the set of visual files from the visual file database comprises:
determining whether a first visual file and a second visual file from the set of visual files are relatable based on at least one of a decision tree, a neural network, a Bayesian network, a genetic algorithm, a support vector machine algorithm, a self organizing map, or a Hidden Markov Model; and
if the first visual file and the second visual file are relatable, forming the set of visual files including the first visual file and the second visual file.

11. The method of claim 1, wherein determining the set of visual files from the visual file database comprises:
attributing a visual file signature to each of the visual files in the visual file database; and
determining the set of visual files based on the set of visual files having substantially similar visual file signatures.

12. The method of claim 1, wherein the set of visual files comprises at least one of an image file or a video file.

13. The method of claim 1, further comprising:
receiving a first visual file;
determining the first visual file is in the set of visual files;
associating the personal identity to the first visual file; and
adding the first visual file and the associated personal identity to the visual file database.

14. The method of claim 1, wherein the data associated with each of the visual files comprises at least one of an image capture device identification, a visual file uploader identification, a geographical tag, a date and/or time stamp, a comment on the visual file, a caption to the visual file, an image capture setting, an object identified in the associated visual file, a person identified in the associated visual file, a pointer to a related visual file, or a photographic style identifier based on the associated visual file.

15. The method of claim 1, wherein determining the personal identity related to the visual file creator comprises:
determining a plurality of people represented in the set of visual files;
determining a social network of people for each of the plurality of people represented in the set of visual files;
determining an intersection of the social networks of people, wherein the intersection includes a single person not represented in the set of visual files; and
associating the personal identity related to the visual file creator to the single person.

16. A machine readable non-transitory medium having stored therein instructions that, when executed, cause a device to attribute a personal identity to a set of visual files by:
determining the set of visual files from a visual file database having a plurality of visual files and data associated with each of the visual files, wherein the set of visual files are attributable to a visual file creator;
determining the personal identity related to the visual file creator attributed to the set of visual files; and
including the personal identity in the data associated with each of the visual files in the set of visual files in the visual file database.

17. The machine readable non-transitory medium of claim 16, wherein determining the personal identity related to the visual file creator comprises:
determining a set of people represented in each visual file of the set of visual files;
determining an intersection of the sets of people represented, wherein the intersection includes a single person; and
associating the personal identity related to the visual file creator to the single person.

18. The machine readable non-transitory medium of claim 16, wherein determining the personal identity related to the visual file creator comprises:
determining a first visual file from the visual file database, wherein the first visual file includes a representation of a creator of at least one visual file of the set of visual files, and wherein the first visual file is not included in the set of visual files;
performing face recognition to determine the personal identity of the representation of the creator of the at least one visual file of the set of visual files; and
associating the personal identity related to the visual file creator to the personal identity of the representation of the creator of the at least one visual file of the set of visual files.

19. The machine readable non-transitory medium of claim 16, wherein determining the personal identity related to the visual file creator comprises:
determining a first visual file from the set of visual files, wherein the first visual file includes a reflective representation of a creator of the first visual file;
performing face recognition to determine the personal identity of the reflective representation of the creator of the first visual file; and
associating the personal identity related to the visual file creator to the personal identity of the representation of the creator of the at least one visual file of the set of visual files.

20. The machine readable non-transitory medium of claim 16, wherein determining the personal identity related to the visual file creator comprises:
determining an identifier related to an image capture device used to capture at least one visual file of the set of visual files;
matching the identifier related to the image capture device to a known identifier in an image capture device ownership database;
identifying an image capture device personal identity related to the known identifier in an image capture device ownership database; and
associating the personal identity related to the visual file creator to the image capture device personal identity.

21. The machine readable non-transitory medium of claim 16, wherein determining the set of visual files from the visual file database comprises at least one of determining the set of visual files are all attributable to a same online alias, determining the set of visual files are all attributable to a same image capture device, determining the set of visual files are all attributable to a same social networking account, determining the set of visual files are all attributable to a substantially similar online location, determining the set of visual files are all attributable to a substantially similar date and physical location, determining the set of visual files all include substantially similar objects or people, determining the set of visual files all include a substantially similar photographic style, or determining the set of visual files all include substantially similar metadata.

22. A device comprising:
a machine readable medium having stored therein instructions that, when executed, cause the device to attribute a personal identity to a set of visual files by:
determining the set of visual files from a visual file database having a plurality of visual files and data associated with each of the visual files, wherein the set of visual files are attributable to a visual file creator;
determining the personal identity related to the visual file creator attributed to the set of visual files; and
including the personal identity in the data associated with each of the visual files in the set of visual files in the visual file database; and
a processor coupled to the machine readable medium to execute the instructions.

23. The device of claim 22, wherein determining the personal identity related to the visual file creator comprises:
determining a set of people represented in each visual file of the set of visual files;
determining a person having the most occurrences in the sets of people represented; and
associating the personal identity related to the visual file creator to the person having the most occurrences.

24. The device of claim 22, wherein determining the personal identity related to the visual file creator comprises:
determining a first visual file from the visual file database, wherein the first visual file includes a representation of a creator of at least one visual file of the set of visual files, and wherein the first visual file is not included in the set of visual files;
performing face recognition to determine the personal identity of the representation of the creator of the at least one visual file of the set of visual files; and
associating the personal identity related to the visual file creator to the personal identity of the representation of the creator of the at least one visual file of the set of visual files.

25. The device of claim 22, wherein determining the personal identity related to the visual file creator comprises:
determining a first visual file from the set of visual files, wherein the first visual file includes a reflective representation of a creator of the first visual file;
performing face recognition to determine the personal identity of the reflective representation of the creator of the first visual file; and
associating the personal identity related to the visual file creator to the personal identity of the representation of the creator of the at least one visual file of the set of visual files.

26. The device of claim 22, wherein determining the set of visual files from the visual file database comprises:
determining whether a first visual file and a second visual file from the set of visual files are relatable based on at least one of a decision tree, a neural network, a Bayesian network, a genetic algorithm, a support vector machine algorithm, a self organizing map, or a Hidden Markov Model; and
if the first visual file and the second visual file are relatable, forming the set of visual files including the first visual file and the second visual file.

27. The device of claim 22, wherein determining the set of visual files from the visual file database comprises:
attributing a visual file signature to each of the visual files in the visual file database; and
determining the set of visual files based on the set of visual files having substantially similar visual file signatures.
